(19) United States
(12) Patent Application Publication
(10) Pub. No.: US 2013/0141374 A1
(43) Pub. Date: Jun. 6, 2013

(54) TOUCHPAD OPERATING AS A HYBRID TABLET

(71) Applicant: CIRQUE CORPORATION, SALT LAKE CITY, UT (US)

(72) Inventor: Richard D. Woolley, Orem, UT (US)

(73) Assignee: CIRQUE CORPORATION, SALT LAKE CITY, UT (US)

(21) Appl. No.: 13/706,665

(22) Filed: Dec. 6, 2012

Related U.S. Application Data
(60) Provisional application No. 61/567,289, filed on Dec. 6, 2011.

(51) Int. Cl. G06F 3/041

(52) U.S. Cl. CPC G06F 3/041
USPC 345/173

(57) ABSTRACT

A method for enabling a touchpad, a relative position device, to operate as if it were a tablet, or absolute position device, so as to provide the same type of input that can be provided by a tablet, wherein a surface of the touchpad is mapped to a surface of the display screen, a finger is detected by the touchpad before it makes contact, the finger may move over the surface of the touchpad causing some visual feedback to occur on the display that indicates the absolute position of the finger as it moves over the touchpad, and making contact with the touchpad to thereby cause selection of an object.

### CROSS REFERENCE TO RELATED APPLICATIONS

This document claims priority to and incorporates by reference all of the subject matter included in the provisional patent application docket number 5083.CIRQ.PR, having Ser. No. 61/567,289, filed Dec. 6, 2011.

### BACKGROUND OF THE INVENTION

1. Field of the Invention

This invention relates generally to touchpad and tablet technology. More specifically, the present invention is a method of enabling a touchpad, which is typically a relative position device, to operate as an absolute position device such as a tablet.

2. Description of Related Art

There are several designs for capacitance sensitive touchpads. It is useful to examine the underlying technology to better understand how any capacitance sensitive touchpad can be modified to work with the present invention.

The CIRQUE® Corporation touchpad is a mutual capacitance-sensing device and an example is illustrated as a block diagram in FIG. 1. In this touchpad 10, a grid of X (12) and Y (14) electrodes and a sense electrode 16 is used to define the touch-sensitive area 18 of the touchpad. Typically, the touchpad 10 is a rectangular grid of approximately 16 by 12 electrodes, or 8 by 6 electrodes when there are space constraints. Interlaced with these X (12) and Y (14) (or row and column) electrodes is a single sense electrode 16. All position measurements are made through the sense electrode 16.

The CIRQUE® Corporation touchpad 10 measures an imbalance in electrical charge on the sense line 16. When no pointing object is on or in proximity to the touchpad 10, the touchpad circuitry 20 is in a balanced state, and there is no charge imbalance on the sense line 16. When a pointing object creates imbalance because of capacitive coupling when the object approaches or touches a touch surface (the sensing area 18 of the touchpad 10), a change in capacitance occurs on the electrodes 12, 14. What is measured is the change in capacitance, but not the absolute capacitance value on the electrodes 12, 14. The touchpad 10 determines the change in capacitance by measuring the amount of charge that must be injected onto the sense line 16 to reestablish or regain balance of charge on the sense line.

The system above is utilized to determine the position of a finger on or in proximity to a touchpad 10 as follows. This example describes row electrodes 12, and is repeated in the same manner for the column electrodes 14. The values obtained from the row and column electrode measurements determine an intersection which is the centroid of the pointing object on or in proximity to the touchpad 10.

In the first step, a first set of row electrodes 12 are driven with a first signal from P, N generator 22, and a different but adjacent second set of row electrodes are driven with a second signal from the P, N generator. The touchpad circuitry 20 obtains a value from the sense line 16 using a mutual capacitance measuring device 26 that indicates which row electrode is closest to the pointing object. However, the touchpad circuitry 20 under the control of some microcontroller 28 cannot yet determine on which side of the row electrode the pointing object is located, nor can the touchpad circuitry 20 determine just how far the pointing object is located away from the electrode. Thus, the system shifts by one electrode the group of electrodes 12 to be driven. In other words, the electrode on one side of the group is added, while the electrode on the opposite side of the group is no longer driven. The new group is then driven by the P, N generator 22 and a second measurement of the sense line 16 is taken.

From these two measurements, it is possible to determine on which side of the row electrode the pointing object is located, and how far away. Pointing object position determination is then performed by using an equation that compares the magnitude of the two signals measured.

The sensitivity or resolution of the CIRQUE® Corporation touchpad is much higher than the 16 by 12 grid of row and column electrodes implies. The resolution is typically on the order of 960 counts per inch, or greater. The exact resolution is determined by the sensitivity of the components, the spacing between the electrodes 12, 14 on the same rows and columns, and other factors that are not material to the present invention.

The process above is repeated for the Y or column electrodes 14 using a P, N generator 24

Although the CIRQUE® touchpad described above uses a grid of X and Y electrodes 12, 14 and a separate and single sense electrode 16, the sense electrode can actually be the X or Y electrodes 12, 14 by using multiplexing.

A touchpad is a relative position device. For the purposes of this document, a relative position device does not have a location that always corresponds to a “center” or any other position set position on a display. Thus, when a user places a finger on a touchpad, the cursor on a corresponding display is associated with the current position of the finger on the touchpad. Placing a finger on the center of the touchpad would thus not cause the cursor to reposition itself at the center of a display.

In contrast, a touchpad disposed over an LCD display is defined as a tablet. A tablet is an absolute position device because the position of the finger on the tablet always corresponds to the position of a cursor or its equivalent.

### BRIEF SUMMARY OF THE INVENTION

In a first embodiment, the present invention is a method for enabling a touchpad, a relative position device, to operate as if it were a tablet, or absolute position device, so as to provide the same type of input that can be provided by a tablet, wherein a surface of the touchpad is mapped to a surface of the display screen, a finger is detected by the touchpad before it makes contact, the finger may move over the surface of the touchpad causing some visual feedback to occur on the display that indicates the absolute position of the finger as it moves over the touchpad, and making contact with the touchpad to thereby cause selection of an object.

These and other objects, features, advantages and alternative aspects of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a block diagram of the components of a capacitance-sensitive touchpad as made by CIRQUE® Corporation and which can be operated in accordance with the principles of the present invention.

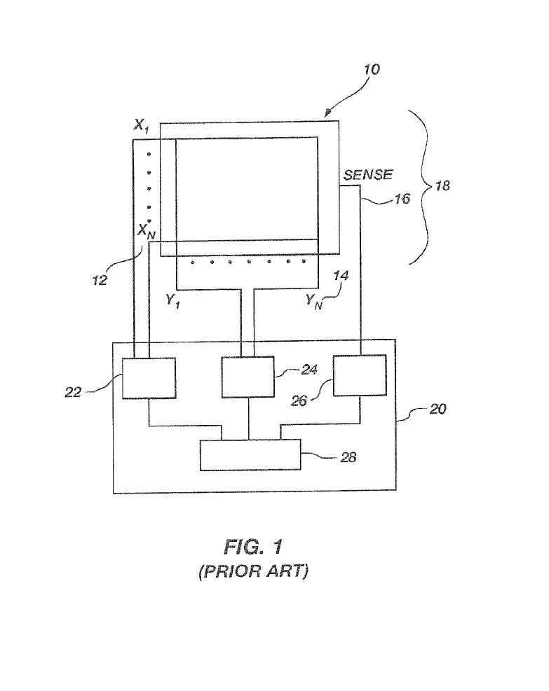

FIG. 2 is a flowchart of the steps for toggling the function of a touchpad from an indirect to a direct input device, hovering a finger over the touchpad and moving it over an object to be selected, selecting the object, and then determining if the touchpad should toggle back to indirect mode or stay in the direct mode of operation.

FIG. 3 is a perspective view of a touchpad, a display screen, and a finger that is hovering over the touchpad.

### DETAILED DESCRIPTION OF THE INVENTION

Reference will now be made to the drawings in which the various elements of the present invention will be given numerical designations and in which the invention will be discussed so as to enable one skilled in the art to make and use the invention. It is to be understood that the following description is only exemplary of the principles of the present invention, and should not be viewed as narrowing the claims which follow.

More and more operating systems or GUIs (graphical user interfaces) could benefit from direct touch (or absolute position) input, such as the input provided by tablet technology, but not all hardware devices come equipped with touchpads disposed over an LCD. Tablet input, absolute position input or direct input simply means that the location of the finger on a touch sensitive surface corresponds directly to a position on a display. Consequently, the touch sensitive surface has been the same size as the display because it is disposed directly on top of the display.

In contrast, laptop or portable computers are typically equipped with a traditional touchpad input device, where the touchpad is generally considered to be an indirect (or relative position) input device because touchpads have not tried to be a direct representation of an entire display when that display is larger than the touchpad itself. In other words, when a user places a finger in the upper left corner of a touchpad, the user does not expect that a cursor will be positioned in the upper left corner of the display. The touchpad is known to represent only a fraction of the display. A user must repeatedly move a finger, lift the finger off the touchpad and reposition the finger back at a beginning point over and over again in order to move a cursor across a display. In other words, the touchpad operates like a computer mouse.

As the traditional touchpad continues to become a more ubiquitous input device, it is more often being combined with new operating systems that can take advantage of direct touch operations offered by tablets. Accordingly, there is a need for the touchpad, which has by definition been separate from the actual display, to provide both indirect or relative position input like a computer mouse, but also direct or absolute position input like a tablet.

The problem with using a traditional touchpad as an absolute or direct input device (hereinafter a “direct input device”), is that the user does not typically have one-to-one feedback, i.e. is not able to correlate the position of touching the touchpad with the desired location of a cursor or other indicator of a finger that is on the touchpad, to a position on the LCD. Accordingly, the present invention is a method for enabling the touchpad to operate in a direct input device mode by providing visual feedback or cue to the user prior to making a “selection” when using a device with a the GUI.

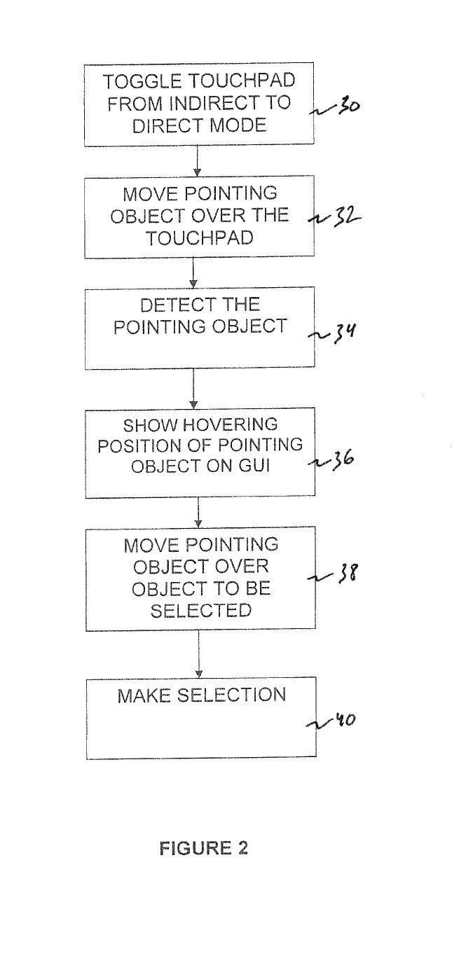

FIG. 2 shows that the first embodiment of the invention is to toggle the touchpad from an indirect input mode to a direct input mode in item 30. The next step 32 is to move a pointing object (hereinafter a “finger”) near to but not touching the surface of the touchpad. As the finger is moved within a proximity sensing range of the touchpad, it is eventually detected by the touchpad in step 34. When the finger is detected, a visual indicator is then shown on the display screen to indicate a corresponding position of the finger before it makes contact with the touchpad in step 36.

The manner in which the corresponding position of the finger may be shown on the display screen may vary. There are many ways in which the position of the finger can be indicated. For example, a cursor may appear or an object other than a cursor may appear which indicates that the finger is hovering and has not yet made contact, or an object may change color, shape or transparency, etc. In other words, there are many ways to visually indicate that the position of the finger over the touchpad corresponds to a particular location on the display screen. Any manner of highlighting a location on the display screen or an object at a location should be considered to be within the scope of the present invention.

Once the corresponding position of the finger is shown on the display screen, the user can continue to move the finger over the touchpad without making contact, or the user may make contact. If no contact is yet made with the touchpad, the visual indicator may move on the display screen in a manner that corresponds to the movements of the finger over the touchpad. What is important to understand is that the touchpad or a portion of the touchpad is now representative of the entire display screen, even if the size of the touchpad is not physically the same size as the display screen.

It should be understood that the length and width dimensions of the touchpad may not correspond to the length and width dimensions of the display screen. This may be referred to as the devices having different aspect ratios. For example, the display screen may have dimensions that correspond to a 16:9 aspect ratio where it is longer in an X dimension and shorter in the Y dimension, and the dimensions of the touchpad may correspond to a 4:3 aspect ratio. For such a combination of touchpad and display screen, there is a 1 to 4 ratio of length units in an X axis, and a 1:3 ratio of length units in a Y axis. This means that movement along different axes will cause a different rate of movement.

The entire surface of the touchpad may be mapped so as to correspond to the entire surface of the display screen. In an alternative embodiment, only a portion of the touchpad may be mapped to the entire surface of the display screen. Alternatively, the entire surface of the touchpad may be mapped to only a portion of the display screen. Thus, any portion of the touchpad may be mapped to any portion of the display screen. The present invention may make any adjustments that are necessary in order to account for differences in the sizes of the surfaces of the touchpad and the display screen. In other words, even though the aspect ratio of the touchpad and the display screen may be different, the present invention may compensate for such differences in order to have the desired mapping from the touchpad to the display screen.

The next step 38 is to move the finger over a location on the display screen where the user wants to make contact or make a selection. Consider a finger, computer pen or stylus that is approaching the touchpad, and then enabling visual feedback to the user so that the user knows where the contact would be made on the display screen if the finger was lowered onto the touchpad. The next step 40 is to enable the user to actually make contact on the touchpad and cause some type of action to occur on the display screen, such as selecting an icon. The user lowers the finger on to the touchpad.

FIG. 2 describes the steps of moving a finger over the surface of the touchpad, being detected by the touchpad before making contact, continuing to move the finger over the touchpad until the user is shown on the display screen that lowering the finger will make contact at a desired location, and then making contact with the finger on the touchpad. The user is helped to decide when to make contact with the touchpad by the visual feedback, in whatever form is desired, on the display screen.

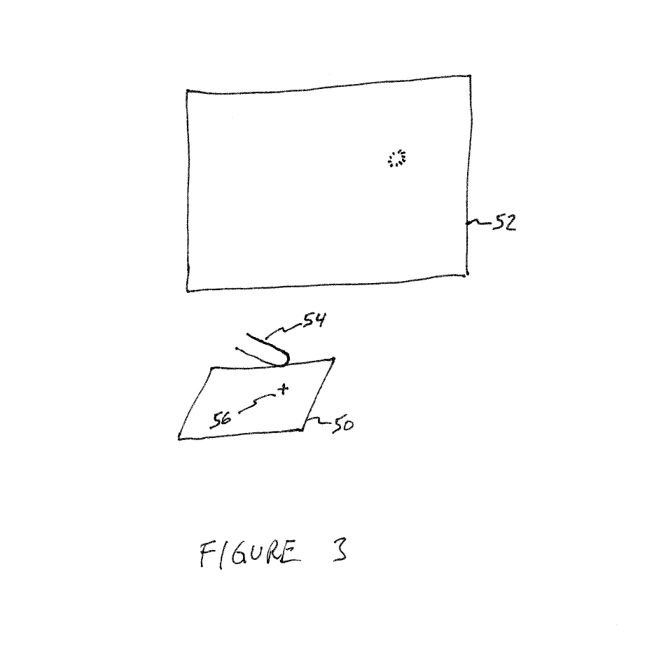

This scenario described above is shown in FIG. 3. FIG. 3 shows a perspective view of a touchpad 50, a display screen 52, and a finger 54 that is hovering over the touchpad, is detected, but is not making contact. The mark X 56 indicates the position on the touchpad 50 over which the finger 54 is hovering. A visual feedback indicator 58 is shown on the display screen 52 that corresponds to the location of the finger over the touchpad 50. The visual feedback indicator 58 is only an example, and should not be considered as limiting as to the nature of the indicator that might be used. In this case, a circle is indicated and outlined by a series of short lines.

After the contact with the touchpad has been made and the desired action has occurred, the user can continue to operate the touchpad in the direct mode, or toggle back to the indirect mode of operation.

The means for toggling between an indirect input mode of operation and a direct input mode may be any convenient method. The means for toggling may be, for example, a switch, a gesture, a virtual button on the touchpad, or a mechanical button on the touchpad. The means for toggling may even be a part of an operating system, or part of a driver that is used with the touchpad. Thus, the means for toggling may be in hardware, software, firmware, or any desired combination.

It has been stated that contact needs to be made with the touchpad in order to actually make the selection. However, in an alternative embodiment, some other method for making the selection might be used, such as increasing the amount of capacitance to ground on the pointing object, or increasing pressure on the touchpad. In other words, the user might be able to actually touch the touchpad without making the selection and then press harder on the touchpad to make the selection. Different touchpad technologies make these selections options possible. For example, the touchpad may use a resistive membrane to detect pressure.

In contrast, if a stylus is being used as the pointing object, the user could activate a switch to cause the capacitive signature of the pointing object to substantially change, which could then be recognized as the step of making a selection.

Another embodiment for making a selection might be to imitate a mouse click by performing a gesture on the touchpad. For example, the user may tap the touchpad once, perform a double tap perform a tap and hold, or any combination of taps and holds. The gesture may be a single finger gesture or a multi-finger gesture. Thus, any desired gesture that the user can perform on the touchpad can be used to make a selection.

It should be understood that once the finger has made contact with the touchpad, the touchpad is still operating in the direct input mode of operation. Thus, if the surface of the display screen is relatively large when compared to the surface of the touchpad, small movements of a finger on the touchpad will cause correspondingly larger movements of an object such as a cursor or a selected object. For example, when the finger reaches the left side of the touchpad surface, the cursor or object may be positioned at the left side of the display screen. Likewise, movement across the surface of the touchpad to the right side may also cause the cursor or object to move all the way to the right side of the display screen.

Another aspect of the present invention is to provide a method for switching the touchpad between its typical indirect input mode of operation and the direct input mode. Some examples of ways in which the operation mode of the touchpad could be switched include but should not be considered limited to making a gesture, or placing one or more different fingers on the touchpad. Thus, any mechanical switch, gesture or other means of causing the operating mode of the touchpad to toggle between direct input mode and indirect input mode should be considered to be within the scope of the present invention.

Up to this point, the invention has described two distinct steps that occur in making a selection when the touchpad is operating in a direct input or tablet mode of operation. First, the pointing object hovers in order to determine which object will be selected if contact is made, and then second, actually making contact in order to make the selection. In another alternative embodiment, a third step may be added to the process. This process of making a selection may be similar to a switch moving from an “off” position when nothing happens, to a “medium” position when feedback information is provided without selection, and then going to an “on” position when a selection is made.

While the embodiments above are directed to the concept of making a selection on a display screen, the term “selection” may be considered to be broader. For example, the user may be positioning a text insertion indicator. Thus, any function where a user is moving objects or selecting objects on a display screen should be considered to be within the scope of the present invention.

It is to be understood that the above-described arrangements are only illustrative of the application of the principles of the present invention. Numerous modifications and alternative arrangements may be devised by those skilled in the art without departing from the spirit and scope of the present invention. The appended claims are intended to cover such modifications and arrangements.

What is claimed is:

1. A method for providing direct and indirect input to a display device from a touchpad, said method comprising:
1) providing a display screen that does not have a touch screen as direct input;
2) providing a touchpad for use with the display screen;
3) providing input to the display screen from the touchpad in an indirect input mode;
4) toggling the touchpad from an indirect input mode to a direct input mode, wherein at least a portion of a surface of the touchpad is mapped so as to directly correspond to at least a portion of a surface of the display screen; and
5) providing input from the touchpad to the display screen in the direct input mode.

2. The method as defined in claim 1 wherein the method further comprises mapping all of a surface of the touchpad to all of a surface of the display screen.

3. The method as defined in claim 2 wherein the method further comprises adjusting the mapping so as to account for differences in an aspect ratio of the touchpad and in an aspect ratio of the display screen.

4. The method as defined in claim 1 wherein the method further comprises toggling the touchpad from the direct input mode back to the indirect input mode.

5. The method as defined in claim 1 wherein the method further comprises:
1) enabling the touchpad to detect a pointing object that is in a proximity of and detectable by the touchpad without making contact with the surface of the touchpad; and
2) providing visual feedback on the display screen that indicates an absolute position of the pointing object above the touchpad.

6. The method as defined in claim 5 wherein the method further comprises enabling movement of the pointing object over the surface of the touchpad to cause corresponding visual feedback on the display screen that indicates the absolute position of the pointing object above the touchpad.

7. The method as defined in claim 5 wherein the step of providing visual feedback further comprises selecting the visual feedback from the group of visual feedback comprised of highlighting an object, changing a shape of an object, changing a color of an object, and creating a cursor or similar object.

8. The method as defined in claim 5 wherein the method further comprises:
1) moving the pointing object until it makes contact with the touchpad; and
2) continuing to operate in the direct input mode.

9. The method as defined in claim 8 wherein the step of making contact with the touchpad further comprises performing a gesture that enables selection of an object that is shown on the display screen.

10. The method as defined in claim 9 wherein the method further comprises selecting the gesture from the group of gestures comprised of tapping, double tapping, tap and hold, a combination of taps and holds, performing a single finger gesture, and performing a multi-finger gesture.

11. A system for providing direct and indirect input to a display device from a touchpad, said system comprised of:
a display screen that does not have a touch screen as direct input;
a touchpad for use with the display screen, wherein the touchpad provides input to the display screen in an indirect input mode;
means for toggling the touchpad from an indirect input mode to a direct input mode, wherein at least a portion of a surface of the touchpad is mapped so as to directly correspond to at least a portion of a surface of the display screen, and providing input from the touchpad to the display screen in the direct input mode when the touchpad is toggled from the indirect input mode to the direct input mode.

12. A method for operating a display device coupled to a touchpad in a direct mode of operation, said method comprising:
1) providing a display screen that does not have a touch screen as direct input, providing a touchpad for use with the display screen, and providing input to the display screen from the touchpad in a direct input mode;
2) mapping all of a surface of the touchpad to all of a surface of the display screen.
3) enabling the touchpad to detect a pointing object that is in a proximity of and detectable by the touchpad without making contact with the surface of the touchpad; and
4) providing visual feedback on the display screen that indicates an absolute position of the pointing object above the touchpad.

13. The method as defined in claim 12 wherein the method further comprises enabling movement of the pointing object over the surface of the touchpad to cause corresponding visual feedback on the display screen that indicates the absolute position of the pointing object above the touchpad.

14. The method as defined in claim 13 wherein the step of providing visual feedback further comprises selecting the visual feedback from the group of visual feedback comprised of highlighting an object, changing a shape of an object, changing a color of an object, and creating a cursor or similar object.

15. The method as defined in claim 13 wherein the method further comprises:
3) moving the pointing object until it makes contact with the touchpad; and
4) continuing to operate in the direct input mode.

16. The method as defined in claim 15 wherein the step of making contact with the touchpad further comprises performing a gesture that enables selection of an object that is shown on the display screen.

17. The method as defined in claim 16 wherein the method further comprises selecting the gesture from the group of gestures comprised of tapping, double tapping, tap and hold, a combination of taps and holds, performing a single finger gesture, and performing a multi-finger gesture.
